(19) United States
(12) Patent Application Publication
(10) Pub. No.: US 2007/0078532 A1
(43) Pub. Date: Apr. 5, 2007

(54) Method for the operation of a technical system

(76) Inventors: Wolfgang Fick, Munich (DE); Uwe Gerk, Frensdorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/577,315

(22) PCT Filed: Oct. 29, 2003
(86) PCT No.: PCT/DE03/03584

§ 371 Date: Apr. 28, 2006

(51) Int. Cl. G05B 13/02; G05B 11/01

(52) U.S. Cl. 700/32; 700/22

(57) ABSTRACT

The invention relates to a method for the operation of a technical system wherein working parameters are detected during a certain period of time. An operational mode and/or functional mode of the technical system are determined by the temporal behavior of said operational parameters, using artificial intelligence methods.

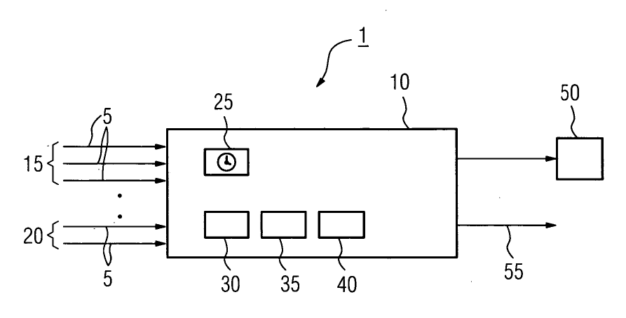

### CROSS REFERENCE TO RELATED APPLICATIONS

This application is the US National Stage of International Application No. PCT/DE03/03584, filed Oct. 29, 2003 and claims the benefit thereof and is incorporated by reference herein in the entirety.

### FIELD OF THE INVENTION

The invention relates to a method for the operation of a technical system, in particular of a power station system.

### BACKGROUND OF THE INVENTION

Modern industrial systems generally have a plurality of system parts which interact with one another in a highly complex manner.

In order to be able to operate a system, operating parameters, at least in the important parts of the system, are usually recorded by sensors and fed into an automation and/or process control system. These operating parameters may be e.g. input parameters which are adjusted by an operator in order to operate a part of the system in a desired manner. For example, in a gas turbine, the fuel and air supply to a combustion chamber has to be adjusted in order to obtain a desired power output of the gas turbine. This power output is also an operating parameter of the gas turbine, which operating parameter can be interpreted as an output parameter.

Also connected to the gas turbine are a generator and numerous other auxiliary operations. Each part of the system has numerous operating parameters which have to be adjusted by a system operator or which emerge as output parameters as a consequence of such adjustments.

It is by implication evident that conclusions and measures for the operation of the technical system can be derived only to a limited degree from the recording of the operating parameters alone. This is at best possible in sub-areas, for example in the emergency shutdown of part of a system if the current value of an operating parameter breaches a limit.

A key difficulty lies in recognizing correlations in the plethora of data on operating parameters so as to be able to influence the operation of the system positively overall.

One solution approach from the prior art consists in using a model to simulate the technical system in order to find out which changes in operating parameters lead to which changes in other operating parameters so as to understand the interactions between the parts of a system or even within a part of a system.

This approach is very costly and susceptible to errors, however, since the modeling of a complex technical system is difficult and is possible only with limited accuracy.

### SUMMARY OF THE INVENTION

The object of the invention is therefore to specify a method for the operation of a technical system by means of which the operating mode of a technical system is determined in a simple manner.

The object is achieved according to the invention in a method for the operation of a technical system wherein operating parameters of at least one part of a system are recorded during a time interval of a freely selectable magnitude and, using artificial intelligence methods comprising at least one method from the group {neuronal network, fuzzy logic, combined neuro/fuzzy method, genetic algorithm}, an operating mode and/or functional mode of the technical system is determined from the temporal behavior of these operating parameters.

The operating parameters in this case also comprise such variables as are determined and made available, for example by status monitoring systems such as e.g. a vibration analysis, as measured variables or derived variables.

The invention is based on the reflection that conclusions as to the current operating mode of the technical system can be drawn from a temporal behavior of operating parameters which are recorded and stored during a time interval, without detailed knowledge of the dependencies of the operating parameters on one another being necessary in advance. In particular, no model of the technical system has to be available in order to be able to make these statements.

The temporal behavior of the operating parameters can for example be recorded by recording a number of operating parameters, contemporaneously in each case, at a current and at a later (or else historical) point in time and by combining these in each case to give a snapshot/fingerprint which can then be compared.

With the aid of known artificial intelligence methods it is possible, if—as provided in the method according to the invention—at least during an observation period the operating parameters attributable thereto and consequently their temporal behavior are recorded, to establish and quantify impacts of changes in a number of operating parameters on the behavior of other operating parameters.

If e.g. during the recording time interval certain operating parameters change (for example, in a linear manner) and certain other operating parameters then also exhibit a change (for example, in a quadratic manner), then this correlation is tracked and quantified using artificial intelligence methods without, for example, a model equation having to exist or to be determined in advance.

The known artificial intelligence methods can learn correlations between operating parameters within a volume of data on operating parameters by analyzing their temporal behavior. The greater the volume of data on operating parameters to be examined, the better the correlations established and the quantification thereof. Once a correlation between certain operating parameters is identified and quantified, the artificial intelligence methods also have the capacity to indicate for such operating parameters and changes therein, for which no map other than previously recorded data records on operating parameters is available, what behavior can be expected from other operating parameters dependent thereon.

By means of the method according to the invention, the operating mode and/or functional mode of the technical system can consequently be determined in a simple manner, in particular without any modeling of the technical function of the system having to be known. The operating mode and/or functional mode is determined by means of the described analysis of the behavior of the operating parameters and of their reciprocal dependencies. The operating parameters recorded during the time interval can be interpreted as snapshots or inventories or even as a characterization of the part of the system or of the system (“fingerprint” of the part of the system or of the system). Here, a fingerprint replaces a traditional model, whereby according to the inventive method conclusions are drawn from the behavior of the operating parameters, using artificial intelligence methods, as to the operating mode and/or functional mode of the technical system. In addition, e.g. in a power station system, fingerprints can be recorded for the startup and shutdown modes as well as for the normal operating mode, in order to become familiar with and identify the respective operating mode.

In a preferred embodiment of the invention, the operating parameters are recorded during at least two temporally separate time intervals, the operating parameters recorded as a dataset in each case are compared with one another and, using artificial intelligence methods comprising at least one method from the group {neuronal network, fuzzy logic, combined neuro/fuzzy method, genetic algorithm}, a prediction is determined as to how the operating parameters must be adjusted in order to achieve a desired operating mode of the technical system.

In this embodiment, a comparison of at least two fingerprints is undertaken, whereby for example the operating parameters changing most significantly in the comparison are selectively examined. This comparison helps to determine which changes in certain operating parameters are necessary in order selectively to influence certain other operating parameters.

A power station system can, for example, be in normal operating mode for days and suddenly the power output falls. A comparison of fingerprints taken from the history of the technical system shows what has changed (e.g. the operating parameters display a significant drop in external air pressure) and also how this can be countered in order to at least maintain output (e.g. the operating parameters also display a drop in combustion air pressure). A prediction is determined by this means, in that through targeted adjustment of selected operating parameters a desired operating mode of the power station system is determined. The prediction preferably comprises the specification of the operating parameters to be changed and their settings as a dataset in order to achieve the desired operating mode.

The comparison may also include the comparison of fingerprints of different systems of the same design as well as the comparison of fingerprints of systems that are merely similar to one another.

In addition to the prediction, it is particularly preferable to determine a degree of confidence which represents a probability that an adjustment of the operating parameters in accordance with the prediction will lead to the desired operating mode. A degree of confidence of, for example, 100% signifies that it can be anticipated with maximum certainty that an adjustment of the operating parameters in accordance with the prediction will lead to the desired operating mode of the technical system. Such a high degree of confidence arises if the currently desired operating mode of the technical system and any boundary conditions (e.g. environmental factors) have already been implemented or occurred in the past and the settings used for the operating parameters as a fingerprint are also known.

In this case, it can thus be assumed with maximum certainty that the technical system will at present again be capable of achieving the desired operating mode.

A degree of confidence of for example 60% may signify that compared with the currently desired operating mode of the technical system no historical operating mode matching this desired operating mode exactly is available as a fingerprint. However, a similar operating mode has existed, so that while it cannot be assumed with maximum certainty that the settings for the operating parameters indicated by the prediction will achieve the desired operating mode, there is nonetheless a good chance of this occurring.

A degree of confidence close to 0% can, for example, indicate furthermore that a comparable desired operating mode of the technical system has never before occurred and consequently the settings for the operating parameters determined in the prediction are subject to a great degree of uncertainty with regard to achievement of the desired operating mode.

The operating mode of the technical system is advantageously determined by means of a correlation analysis of the operating parameters, whereby the impacts of changes in operating parameters which correspond to input parameters on operating parameters which correspond to output parameters are determined.

In this embodiment, impacts of a change in input parameters on output parameters dependent thereon are selectively detected and quantified.

Input parameters are usually operating parameters whose values either have to be adjusted by an operator of the technical system or are fixed by boundary conditions such as, for example, environmental influences.

Output parameters are such operating parameters as are produced as a consequence of adjusting the input parameters and are consequently dependent on these; the correlation analysis investigates the type of correlation and quantifies this.

Ideally, in a technical system the operating parameters of all the key parts of the system are recorded so that using a method according to the invention the operating parameters of the whole technical system can be determined and adjusted in a simple manner; the inventive method may form a control system by means of which one or more parts of a system, as well as the technical system as a whole, are controlled by means of closed control loops. In the method according to the invention, a database map of operating parameters is generated. This map allows the operator of the technical system to derive correlations between operating parameters and the operating mode of the technical system, to match own knowledge with the recorded data and to steer toward desired modes of operation of the technical system in a targeted manner. Preferably, multiple fingerprints are compared with one another in order to identify which findings can be translated from one operating mode to another operating mode. The corresponding results and predictions can easily be stored as datasets and retrieved at any time as required.

### BRIEF DESCRIPTION OF THE DRAWINGS

An embodiment of the invention is shown in detail below.

FIG [lacuna] shows a processing system for implementing the method according to the invention.

### DETAILED DESCRIPTION OF THE INVENTION

The Figure shows a processing system 1 comprising a processing unit 10 for implementing the method according to the invention. Operating parameters 5 of a technical system are fed to the processing unit 10, which operating parameters comprise input parameters 15 and output parameters 20.

A timer 25 serves to select a relevant time interval during which the operating parameters 5 are to be recorded.

The temporal behavior of the operating parameters 5 during the time interval is investigated using a neuronal network 30 and/or a neuro/fuzzy functional unit 35 and/or one or more genetic algorithms 40 and from this a correlation between at least some of the input parameters 15 and at least some of the output parameters 20 is detected and quantified. Finally, knowledge of this correlation permits the preparation of a dataset 50 which comprises settings for at least some of the operating parameters 5 in order to achieve a desired operating mode of a part of a technical system. This dataset 50 represents a prediction as to how certain operating parameters must be adjusted in order to realize the desired operating mode of the technical system. In addition, a degree of confidence 55 is output by the processing unit 10, which degree of confidence represents a probability that an adjustment of the operating parameters in accordance with the data of the dataset 50 will lead to the desired operating mode.

Inside the processing unit 10, an analysis of the correlation between the input parameters 15 and the output parameters 20 takes place so that, with the aid of the knowledge of the temporal behavior of the input parameters 15 and the output parameters 20 connected with these, [lacuna] the operating mode and functional mode of the technical system is possible and datasets 50 can be prepared for desired modes of operation of the technical system, for which in the past no operating parameters 5 with the corresponding input parameters 15 and output parameters 20 have been recorded. The processing unit 10 is to this extent capable of interpolation.

1-4. (canceled)

5. A method for the operation of a technical system, comprising:
recording a plurality of operating parameters of a system during a time interval; and
determining an operating or functional mode of the technical system from the temporal behavior the operating parameters using artificial intelligence methods selected from the group consisting of: neuronal network, fuzzy logic, combined neuro/fuzzy method, and genetic algorithm.

6. The method according to claim 5, wherein an operating and a functional mode of the technical system are determined from the temporal behavior the operating parameters using artificial intelligence methods selected from the group consisting of: neuronal network, fuzzy logic, combined neuro/fuzzy method, and genetic algorithm.

7. The method according to claim 5, wherein the operating parameters are recorded as data sets during a plurality of temporally separate time intervals and the data sets are compared using the artificial intelligence methods, and an adjustment of the operating parameters is determined in order to achieve a desired operating mode of the technical system.

8. The method according to claim 7, wherein a probability that an adjustment of the operating parameters provides for the desired operating mode is determined.

9. The method according to claim 8, wherein the operating mode of the technical system is determined using a correlation analysis of the operating parameters, wherein the result of changes in operating parameters that correspond to input parameters is determined based on operating parameters which correspond to output parameters.

10. A method of controlling the operation of a power station, comprising:
recording operating parameters of at least part of a system during a time interval;
determining an operating mode or functional mode of the technical system from the temporal behavior the operating parameters using artificial intelligence methods selected from the group consisting of: neuronal network, fuzzy logic, combined neuro/fuzzy method, and genetic algorithm;
assigning a fingerprint to the operating parameter by the artificial intelligence method;
comparing the fingerprint to a predetermined fingerprint; and
adjusting the operating parameters of the power station in order to achieve a desired operation of the power station.

11. The method according to claim 10, wherein a probability that an adjustment of the operating parameters provides for the desired operating mode is determined.

12. The method according to claim 11, wherein the operating mode of the power station is determined using a correlation analysis of the operating parameters, wherein the result of changes in operating parameters that correspond to input parameters is determined based on operating parameters which correspond to output parameters.
